(19) United States
(12) Patent Application Publication
(10) Pub. No.: US 2025/0276302 A1
(43) Pub. Date: Sep. 4, 2025

(54) SMART CATALYST SUPPORT WITH IN-SITU TEMPERATURE FIELD MONITORING AND DYNAMIC REGULATION

(71) Applicant: XIAMEN UNIVERSITY, Xiamen (CN)

(72) Inventors: Wei ZHOU, Xiamen (CN); Wenjun XU, Xiamen (CN); Xinying LI, Xiamen (CN); Tao LUO, Xiamen (CN); Yao MA, Xiamen (CN); Chao GAO, Xiamen (CN); Linjing WU, Xiamen (CN)

(73) Assignee: XIAMEN UNIVERSITY, Xiamen (CN)

(21) Appl. No.: 19/209,840

(22) Filed: May 16, 2025

Related U.S. Application Data
(63) Continuation of application No. PCT/CN2024/127709, filed on Oct. 28, 2024.

(30) Foreign Application Priority Data
Nov. 1, 2023 (CN) 202311437562.8

(51) Int. Cl. B01J 20/32; B01J 35/33; B01J 35/50; B01J 35/55; B01J 37/08; B33Y 80/00

(52) U.S. Cl. CPC B01J 20/3204; B01J 35/33; B01J 35/505; B01J 35/55; B01J 37/084; B33Y 80/00; B01J 2219/00961

(57) ABSTRACT

A smart catalyst support with real-time temperature field monitoring and dynamic regulation in the reaction zone is provided. Specifically for a variety of different properties of the material composition of the three-dimensional porous structure; three-dimensional porous structure using multi-material 3D printing technology and selective carbonization process manufacturing and forming; the three-dimensional porous structure consists of three parts: thermoelectric phase, conductor phase and structural phase, responsible for temperature field perception, temperature field regulation and electrical isolation, respectively; temperature field sensing is realized by the combination of thermoelectric phase and conductor to form a thermocouple using the Seebeck effect; temperature field regulation is realized by generating joule heat to the input current of the conductor phase; the temperature field sensing and temperature field regulation process are interconnected from electrical isolation by structural phase, using the insulation properties of the structural phase to achieve.

### CROSS REFERENCE TO THE RELATED APPLICATIONS

This application is a continuation application of International Application No. PCT/CN2024/127709, filed on Oct. 28, 2024, which is based upon and claims priority to Chinese Patent Application No. 202311437562.8, filed on Nov. 1, 2023, the entire contents of which are incorporated herein by reference.

### TECHNICAL FIELD

The invention belongs to the field of microreactor technology, and specifically relates to a smart catalyst support for dynamically in-situ monitoring and regulating the temperature field in a reaction zone.

### BACKGROUND

Microreactor technology refers to the use of microreactors for conducting chemical reactions, where the volume and mass of the reactants are at the micrometer scale. This facilitates precise and efficient heat and mass transfer, thereby enhancing reaction efficiency. Compared to traditional large-scale reactors, microreactor technology boasts rapid heat and mass transfer, high reaction efficiency, and sustainable production, offering an innovative and effective method for the research and production in fine chemical engineering. In recent years, researchers have conducted extensive investigations into aspects such as the structure of catalyst support, reactor design, catalysts, and heating methods, propelling the rapid development of microreactor technology. However, the application of microreactors in fine chemical engineering faces the “black box” dilemma, where the microscopic-scale reaction processes are difficult to observe and control during actual operation. Among these, temperature, as one of the core variables in chemical reactions, reflects the energy conversion process of chemical reactions. For the vast majority of chemical reactions, there is a challenge in dynamically balancing the reaction energy changes with external temperature, which can easily lead to positive feedback effects in localized areas, causing the reaction to go out of control or fail. Therefore, the dynamic selection and control of temperature is a critical challenge that needs to be overcome to achieve ideal reaction outcomes.

In terms of temperature control, traditional microreactors use heating rods for external heating, supplying heat to the reaction zone through thermal conduction. However, this method results in significant temperature gradients within the reaction zone and cannot achieve localized temperature control. Emerging applications of internal heat sources such as Joule heating, microwave heating, and ultrasonic heating in microreactors have effectively reduced temperature gradients in the reaction zone, but they still struggle to dynamically control localized reaction temperatures. The first step towards achieving dynamic temperature control is to obtain dynamic temperature information of the reaction zone. In terms of temperature sensing, limited by the small size of the reaction zone and relatively extreme working conditions, current temperature distribution in the reaction zone is mostly inferred from the final product outcomes. Methods such as simulation or measuring the external wall temperature of the reactor cannot accurately reflect the internal conditions. While invasive devices like thermocouples and thermistors can be used for measurement, the devices themselves interfere with the actual reaction process, and the deviation from the real situation increases with the scale of measurement points. Fiber optic sensors, with their size advantage, can somewhat mitigate this impact, but they still struggle to reconcile the contradiction between measurement points and measurement distortion, making it difficult to expand the measurement scale. Additionally, due to material property limitations, fiber optic sensors have poor chemical compatibility, limited application temperature range, and affect local heat transfer, making them an ineffective solution for obtaining a three-dimensional temperature field in the reaction zone.

### SUMMARY

The object of the present invention is to overcome the defects existing in the prior technology, provide a smart catalyst support to realize the real-time monitoring and regulation of the temperature field of the reaction area, realize the real-time monitoring and regulation of the temperature field of the reaction process, solve the “black box” dilemma faced by the microreactor in fine chemical applications, and improve the dynamic controllability of the chemical reaction.

To achieve the above purpose, One of the technical schemes of the present invention is a smart catalyst support for realizing the in-situ monitoring and regulation of the temperature field in the reaction area. A three-dimensional porous structure composed of a variety of materials with different properties; The three-dimensional porous structure is formed by using multi-material 3D printing technology and selective carbonization process; The described three-dimensional porous structure has the function of temperature field sensing and temperature field regulation, It consists of a thermoelectric phase, a conductor phase, and a structural phase; The temperature field sensing is realized by the combination of the thermoelectric phase and the conductor to form a thermocouple using the Seebeck effect; The temperature field regulation is achieved by generating Joule heat through the input current of the conductor phase; Part of the catalyst supports of temperature field sensing and temperature field regulation are connected by the structural phase of electrical insulation.

In a preferred embodiment of the present invention, the shape of the smart catalyst support is a regular or irregular cuboid or cylinder or the like.

Further preferably, the cuboid has a length of 5 mm to 1000 mm, a width of 5 mm to 1000 mm and a thickness of 1 mm to 20 mm, and the cylinder has a length of 5 mm to 1000 mm and a diameter of 1 mm to 20 mm.

In a preferred embodiment of the present invention, the smart catalyst support is composed of a lattice-like truss structure unit.

In a preferred embodiment of the present invention, the cross section feature size of the truss structure unit is 10 μm to 500 μm, the cross-sectional shape is circular, oval, rectangular, triangular, random polygonal, porous, or other irregular shapes.

In a preferred embodiment of the present invention, the material property mainly refers to the conductivity and the Seebeck coefficient.

In a preferred embodiment of the present invention, the carbon material is formed by pyrolysis of the polymer; one or more materials of polylactic acid (PLA), acrylonitrile-butadiene-styrene (ABS), polyamide (PA), polycarbonate (PC), polycarbonate, thermoplastic-polyurethane (TPU), epoxy resin, and the like.

Further preferably, the polymer pyrolysis is achieved by using a vacuum sintering furnace, atmosphere sintering furnace, plasma sintering furnace and other equipment combined with a certain heating procedure.

Further preferably, the heating procedure is as follows: the pyrolysis temperature is 300-1000° C., the heating rate is 0.5-25° C./min, and the pyrolysis time is 20-500 min.

In a preferred embodiment of the present invention, the multi-material 3D printing technology includes inkjet 3D printing, fused deposition modeling (FDM), selective laser sintering (SLS), stereolithography (SLA), digital light processing (DLP) and powder pressing technology.

In a preferred embodiment of the present invention, the selective carbonization process controls the electrical characteristics of the polymer with the catalyst support concentration at different spatial positions of the porous structure by varying the content of the catalyst inside of the polymer.

Further preferably, the catalyst is one or more of the metal catalyst, carbon-based catalyst, oxide catalyst and calcium-based catalyst.

Further preferred, the metal catalyst including iron (Fe), cobalt (Co), nickel (Ni) transition group metal catalysts and platinum (Pt), palladium (Pd), carbon based catalysts including carbon nanotubes, carbon black, oxide catalysts including iron oxide (Fe₂O₃), three iron oxide (Fe₃O₄), zinc oxide (ZnO), calcium based catalysts including calcium oxide (CaO), calcium carbonate (CaCO₃).

In a preferred embodiment of the present invention, the thermoelectric phase is a lower content catalyst added to the carbonization precursor, so that the partial structure has a certain Seebeck coefficient and a small resistance after carbonization at the same temperature conditions.

Further preferably, the catalyst content is 10 to 25% wt; the Seebeck coefficient is 30 to 200 μV/K and the resistance is 0.5 to 20 kΩ.

In a preferred embodiment of the invention, the conductor phase is a higher content catalyst in the carbonization prepolymer, so that the partial structure has a minimal Seebeck coefficient and resistance after carbonization at the same temperature.

Further preferably, the catalyst content is 30 to 60% wt. The Seebeck coefficient is 0 to 5 μV/K, and the resistance is 0 to 50.

In a preferred embodiment of the present invention, the structural phase is that the partial structure has a large resistance after having been carbonized at the same temperature, and the resistance is >150 MΩ.

In a preferred embodiment of the present invention, the temperature sensing function of the smart catalyst support is to combine a thermoelectric phase with a conductor to form a plurality of thermocouple junctions, sensing the point temperature using the Seebeck effect.

Further preferably, the smart catalyst support has 10 to 100 thermocouple junctions formed by combining the thermoelectric phases and the conductors, which can form a three-dimensional temperature field of the reaction region.

Further preferably, the thermoelectric phase output voltage of each node and the conductor phase input voltage of each module form a closed loop through a computer program, and adjust the input voltage of each module in combination with the temperature range requirements of different reaction systems, so as to intelligently control the temperature field of the reaction area.

In a preferred embodiment of the present invention, the smart catalyst support has 2 to 25 heating modules, with input leads connected at each of them, providing heat in the reaction area by the joule heating, and fine control of the temperature of the reaction area can be achieved by adjusting the input power of each heating module.

The beneficial effect of the present invention compared with the prior art lies in:

The invention combines multi-material 3D printing technology and selective carbonization technology is constructed of thermoelectric phase, conductor phase and structural phase of thermal control smart catalyst support, the catalyst support itself in porous medium in chemical reaction process strengthening heat transfer mass transfer, enhance diffusion structure function, also has the function of modular heating and 3D temperature field induction, reducing the real working conditions reaction area in real time temperature field, realize the closed loop control of reaction area 3D temperature field, suitable for any reaction process requires accurate control of temperature interval, provides an effective solution for the controllability problem of fine chemical industry.

### BRIEF DESCRIPTION OF THE DRAWINGS

FIG. 1 is a schematic diagram and structural design diagram of the temperature field control smart catalyst support of the present invention;

FIG. 2 is the plane structure design drawing of the thermoelectric layer.

### DETAILED DESCRIPTION OF THE EMBODIMENTS

In order to clarify the objectives, technical scheme and advantages of the invention, the invention is described in more detail combined with the following drawings and specific embodiments, but the scope of protection of the invention is not limited to these embodiments. The same reference marks in the text always represent the same elements, and the similar reference marks represent similar elements.

In the description of the present invention, it is necessary to be understood that the terms “up”, “down”, “front”, “back”, “after”, “left”,

The orientation or position relationship such as “right”, “horizontal”, “vertical”, “top”, “bottom”, “inside”, “outside” are based on the orientation or position relationship shown in the stereodiagram in the attached drawings, only to facilitate the description of the invention and simplify the description, rather than indicating or implying that the device or element must be constructed and operated in a specific orientation, and thus cannot be understood as a limitation of the present invention.

A smart catalyst support with real-time temperature field monitoring and dynamic regulation in the reaction zone. A three-dimensional porous structure composed of a variety of materials with different properties; The three-dimensional porous structure is formed by using multi-material 3D printing technology and selective carbonization process; The three-dimensional porous structure consists of three parts: thermoelectric phase, conductor phase and structural phase, Responsible for the role of temperature field perception, temperature field regulation and electrical isolation respectively; The temperature field sensing effect is realized by the combination of the thermoelectric phase and the conductor to form a thermocouple using the Seebeck effect; The temperature field regulation effect is realized by generating Joule heat on the input current of the conductor phase; The temperature field sensing and temperature field regulation process are separated by the structural phase, Using the insulation properties of the structural phase to achieve.

The shape of the smart catalyst support is a regular or irregular cuboid or cylinder, etc.

The length is 5 mm to 400 mm, 5 mm to 400 mm, the thickness is 1 mm to 20 mm, and the length is 5 mm to 400 mm and the diameter is 1 mm to 20 mm.

The smart catalyst support is composed of a lattice truss structure unit.

The cross section feature size of the truss structure unit is 10 μm-500 μm, the cross-sectional shape is circular, oval, rectangular, triangular, random polygonal, porous, or other irregular shapes.

The material attribute mainly refers to the electrical conductivity and the Seebeck coefficient.

The carbon material is formed by pyrolysis of the polymer; the polymer is one or more of polylactic acid (PLA), acrylonitrile-butadiene-styrene (ABS), polyamide (PA), polycarbonate (PC), thermoplastic polyurethane (TPU), epoxy resin and other materials.

The polymer pyrolysis is realized by using vacuum sintering furnace, atmosphere sintering furnace, plasma sintering furnace and other equipment combined with certain heating procedures.

The heating procedure is as follows: the pyrolysis temperature is 300-1000° C., the heating rate is 0.5-25° C./min, and the pyrolysis time is 20-500 min.

The multi-material 3D printing technology includes ink-jet 3D printing, fused deposition modeling (FDM), selective laser sintering (SLS), stereolithography (SLA), digital light processing (DLP) and powder pressing technology.

The selective carbonization process uses the characteristics of the catalyst support concentration in different spatial positions of the polymer, and changes the content of the catalyst in the polymer, and then controls its electrical characteristics.

The catalysts are one or more of metal catalysts, carbon-based catalysts, oxide catalysts and calcium-based catalysts.

The metal catalyst includes iron (Fe), cobalt (Co), nickel (Ni) and platinum (Pt), palladium (Pd), carbon based catalyst including carbon nanotubes, graphene, oxide catalyst including iron oxide (Fe₂O₃), three iron oxide (Fe₃O₄), zinc oxide (ZnO), calcium based catalyst including calcium oxide (CaO), calcium carbonate (CaCO₃).

The thermoelectric phase is a lower catalyst in the carbonization precursor, so that the partial structure has a certain Seebeck coefficient and a small resistance after carbonization at the same temperature conditions.

The catalyst content is 10 to 25% wt; the Seebeck coefficient is 30 to 200 μV/K, and the resistance is 0.5 to 20 kΩ.

The conductor phase is a catalyst with a higher content added to the carbonization precursor, so that the partial structure has a minimal Seebeck coefficient and resistance after carbonization at the same temperature.

The described catalyst content is from 30 to 60% wt. The Seebeck coefficient is 0 to 5 μV/K, and the resistance is 0 to 5Ω.

The structural phase is the large resistance of the structure after carbonization, at the same temperature, and the resistance is >150 MΩ.

The temperature sensing function of the smart catalyst support is to combine the thermoelectric phase with the conductor to form multiple thermocouple junctions, and to sense the point temperature by using the Seebeck effect.

The smart catalyst support has 10 to 100 thermocouple junctions formed by the combination and conductor, which can form a three-dimensional temperature field in the reaction region.

The thermoelectric phase output voltage of each junction and the conductor phase input voltage of each module form a closed loop through a computer program, and adjust the input voltage of the respective module according to the temperature range requirements of different reaction systems, so as to intelligently control the temperature field in the reaction area.

The smart catalyst support has 2 to 25 heating modules, with input leads at each heating module. Joule heat is used to provide heat in the reaction area, and fine control of the temperature of the reaction area can be realized by adjusting the input power of each heating module.

### Example 1

A smart catalyst support with real-time temperature field monitoring and dynamic regulation in the reaction zone. The thermoelectric phase, conductor phase and structural phase are three-phase composition. The three-phase materials are all carbon body composite materials formed after the carbonization of the polymer precursor. The catalyst used in the embodiment is a carbon nanotube, adding 40% carbon nanotube as the conductor phase, the resistance of the conductor phase after the carbonization is 10Ω, the Seebeck coefficient is 2 u V/K; adding 20% carbon nanotubes to the acrylate as the thermoelectric phase results in a resistance of 5 kΩ and the Seebeck coefficient is 50 μV/K; the acrylic ester not incorporating the catalyst as the structural phase, and the resistance of the conductor phase is >200 MΩ.

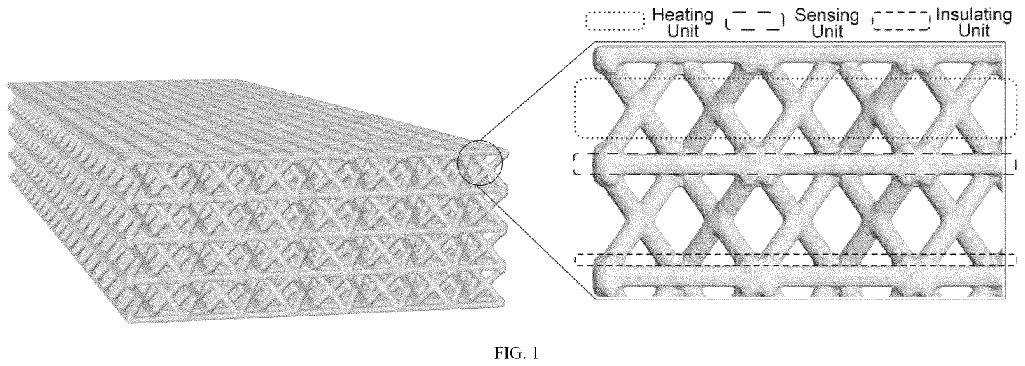

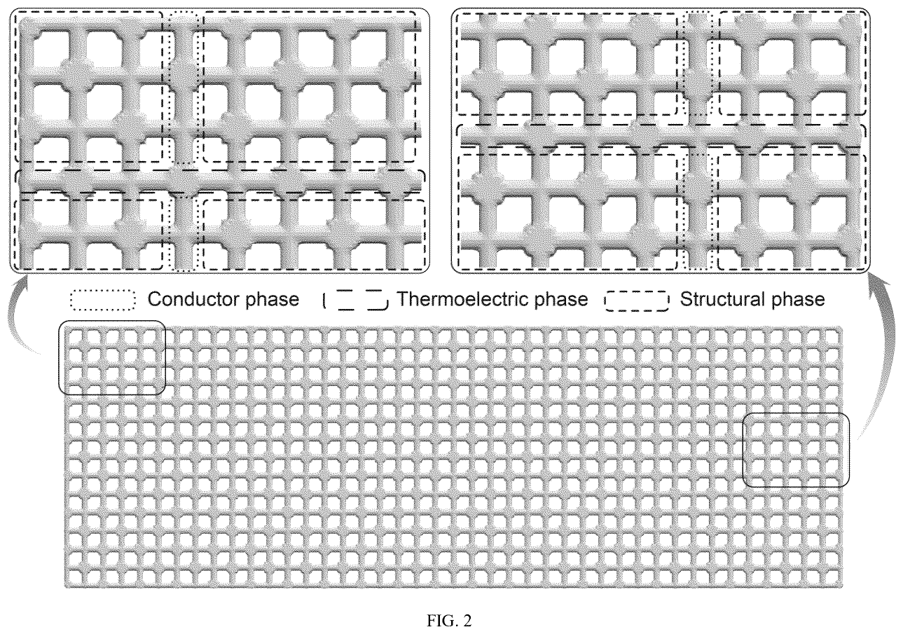

3D porous catalyst support structures through 3D modeling software, As shown in FIG. 1, The smart catalyst support adopts a layered design, Three-dimensional porous structure is formed by alternating stacking of the heating unit and the sensing unit, The sensing unit and the heating unit are separated from the electricity through the structural phase; The material body of the heating unit is the conductor phase, Enter currents of different sizes to the two ends of multiple heating cells, temperature field regulation can be performed by using Joule heat; The sensing unit is composed of three materials: thermoelectric phase, conductor phase and structural phase, As shown in FIG. 2, The thermoelectric phase and the conductor phase cross each other to form multiple thermocouple junctions, Real-time sensing of the temperature field by using the Seebeck effect, While the rest maintains the morphology of the porous structure through structural phase.

Using multi-material light curing 3D printing technology. The shape of the smart catalyst support is a regular cuboid, with a length of 300 mm, a width of 700 mm and a thickness of 2 mm. The interior of the smart catalyst support is composed of lattice truss structure units, with a circular cross section and a feature size of 300 μm. The pre-carbonized porous catalyst support is placed in a vacuum sintering furnace for carbonization, and the setting procedure is as follows: heating rate is 5° C./min, insulation temperature is 650° C., and insulation time is 60 min. The smart catalyst support has 50 thermocouple junctions formed by the combination of thermoelectric phase and conductor, which can form a three-dimensional temperature field in the internal area of the catalyst support. The smart catalyst support has 10 heating modules at the same time, each heating module is connected with the input lead, to generate the heat needed inside the catalyst support by joule heat. The sensing node of seebeck output voltage and the heating module through the computer program input current closed loop control, combined with the different reaction system of temperature range and sensing unit output of 3D temperature field information, adjust the heating module to the joule heat intensity, can realize the reaction area three-dimensional temperature field real-time intelligent control. The manufactured smart catalyst support is placed as the reaction catalyst support in the methanol reforming hydrogen production microreactor, and the temperature interval of the control software is set at 260-280° C. The temperature of the microreactor is within the optimal reaction temperature range, and the real-time monitoring and control of the temperature field in the methanol reforming hydrogen production microreactor is realized.

The above embodiments are only used to explain the technical solutions of the invention, not limitations; despite the detailed description of the invention, the ordinary technicians in the art should understand that the invention can modify the aforementioned embodiments or replace some or all of the technical features; these modifications or replacement do not separate the nature of the corresponding technical solutions from the scope of the various embodiments of the invention.

What is claimed is:

1. A smart catalyst support with a real-time temperature field monitoring and a dynamic regulation in a reaction zone, wherein a three-dimensional porous structure comprising a plurality of materials with different properties; the three-dimensional porous structure is fabricated using a multi-material 3D printing technology and a selective carbonization process; the selective carbonization process leverages a characteristic that polymers exhibit significant differences in a catalyst support concentration at varying carbonization degrees, and controls the carbonization degree at different spatial locations of the three-dimensional porous structure by adjusting a catalyst content in the polymer, thereby regulating electrical properties of the three-dimensional porous structure; the three-dimensional porous structure integrates a temperature field sensing function and a temperature field regulation function, comprising a thermoelectric phase, a conductive phase, and a structural phase;
the thermoelectric phase is formed by adding 10-25 wt % catalyst to a pre-carbonization polymer, resulting in a post-carbonization Seebeck coefficient of 30-200 μV/K and an electrical resistance of 0.5-20 kΩ under first identical temperature conditions; the conductive phase is formed by adding 30-60 wt % catalyst to the pre-carbonization polymer, resulting in a post-carbonization Seebeck coefficient of 0-5 μV/K and an electrical resistance of 0-5Ω under second identical temperature conditions; and the structural phase contains no additional catalyst in the pre-carbonization polymer, resulting in a post-carbonization electrical resistance of >150 MΩ under third identical temperature conditions;
the temperature field sensing function is achieved by combining the thermoelectric phase and the conductive phase to form thermocouples utilizing Seebeck effect; the temperature field regulation function is realized by inputting a current into the conductive phase to generate Joule heating; and the structural phase, maintains interconnections between portions of a catalyst support responsible for the temperature field sensing function and the temperature field regulation function, wherein the structural phase is electrically insulating; and
the temperature field sensing function of the smart catalyst support is implemented by forming 10-100 thermocouple junctions through a combination of the thermoelectric phase and the conductive phase, enabling a point-temperature detection via the Seebeck effect; the smart catalyst support comprises 2-25 heating modules; an output voltage of the thermoelectric phase and an input voltage of the 2-25 heating modules are linked through a computer program to form a closed-loop system, wherein the closed-loop system dynamically adjusts the input voltage of each of the 2-25 heating modules according to temperature range requirements of different reaction systems, thereby achieving an intelligent temperature field control in the reaction zone.

2. The smart catalyst support according to claim 1, wherein a shape of the smart catalyst support is regular or irregular rectangular or cylinders, a length of the regular or irregular rectangular is 5 mm to 400 mm, a width of the regular or irregular rectangular is 5 mm to 400 mm, a thickness of the regular or irregular rectangular is 1 mm to 20 mm, and a length of the cylinder is 5 mm to 400 mm and a diameter of the cylinder is 1 mm to 20 mm.

3. The smart catalyst support according to claim 1, wherein the smart catalyst support comprises a lattice truss structure unit; and the lattice truss structure unit has a feature size of 10 μm to 500 μm, and a cross section shape of the lattice truss structure unit is circular, elliptical, rectangular, triangular, or random, random porous, and irregular shape.

4. The smart catalyst support according to claim 1, wherein the material is formed by a polymer pyrolysis; the polymer is one or more materials of polylactic acid (PLA), acrylonitrile-butadiene-styrene (ABS), polyamide (PA), polycarbonate (PC), thermoplastic polyurethane (TPU), epoxy resin, and the like.

5. The smart catalyst support according to claim 1, wherein a polymer pyrolysis is achieved by using a vacuum sintering furnace, an atmosphere sintering furnace, a plasma sintering furnace, and the like: a pyrolysis temperature is 300 to 1000° C., a temperature speed is 0.5-25° C./min, and a pyrolysis time is 20-500 min.

6. The smart catalyst support according to claim 1, wherein the multi-material 3D printing technology comprises ink-jet 3D printing, fused deposition modeling (FDM), selective laser sintering (SLS), stereolithography (SLA), digital light processing (DLP), and powder pressing technology.

7. The smart catalyst support according to claim 1, wherein the catalyst is one or more of a metal catalyst, a carbon based catalyst, an oxide based catalyst, and a calcium based catalyst; and the metal catalyst comprises a transition group metal catalyst, the carbon based catalyst comprises carbon nanotubes and graphene, the oxide based catalyst comprises iron oxide, four iron oxide, and zinc oxide, and the calcium based catalyst comprises calcium oxide and calcium carbonate.
